(19) United States
(12) Patent Application Publication
(10) Pub. No.: US 2012/0118700 A1
(43) Pub. Date: May 17, 2012

(54) DEVICE FOR THE RETURN OF EMPTIES, IN PARTICULAR PLASTIC BOTTLES AND METAL CANS

(76) Inventor: Bert Handschick, Olbersdorf (DE)

(21) Appl. No.: 13/263,049

(22) PCT Filed: Feb. 5, 2010
(86) PCT No.: PCT/DE10/00144

§ 371 Date: Dec. 16, 2011

(30) Foreign Application Priority Data
Apr. 9, 2009 (DE) 10 2009 017 211.4

(51) Int. Cl. B65G 47/46; B65G 47/34

(52) U.S. Cl. 198/370.11; 198/370.01

(57) ABSTRACT

The present invention relates to an apparatus for recovering empty containers, in particular plastic bottles and metal cans, in which the empty containers are guided by a conveying means from a collecting chamber (bulk input) past detectors belonging to a detection unit, and discharging means for removing the empty containers from the conveying means are arranged downstream of the detection unit, in the conveying direction. The aim of the invention is to provide such an apparatus with an increased throughput. This aim is solved according to the invention in that the conveying means is configured as an inclined conveyor (3) which removes the empty containers (10) in a parallel manner on carriers (8, 28) from the collecting space (11) and feeds them to the detectors (15, 32, 33) in a uniformly spaced arrangement. The apparatus also has discharging means (16, 17) which extend transversely in at least two rows, on different levels, over the entire width of the inclined conveyor (3). A further feature of the invention is that discharging means (16, 17) are assigned conveyer belts (18, 19) for advancing the discharged empty containers (10).

### RELATED APPLICATIONS

The present application claims priority from PCT International Application No. PCT/DE2010/00144 filed Feb. 5, 2010, which claims priority from German Patent Application No. 10 2009 017 211.4 filed Apr. 9, 2009, the contents of all of which are incorporated herein by reference.

### TECHNICAL FIELD

The present invention relates to a device for recovering empties, in particular of plastic bottles and metal cans, as disclosed herein.

### BACKGROUND

Devices such as disclosed herein are used in automatic machines for the recovery of empties among other things. By means of these automatic machines, disposable and returnable empties, such as bottles and cans, are recovered. In this context, individual feed systems and bulk feed systems are differentiated.

An example of an automatic machine for the recovery of empties with an individual feed system can be found in WO 02/12095 A1. With such automatic machines, the empties are serially input manually one after the other and then fed serially by a conveying system, i.e., in a row, individually one after another past a detection unit, which will check the empties in terms of their shapes and optionally for additional characteristics.

Automatic machines for the return of empties with bulk feed systems are described in DE 10 2005 025 965 A1, DE 10 2004 010 133 A1, and DE 103 35 188 A1. With these automatic machines, returned empties are not fed individually, i.e., piece by piece, but rather in bulk, i.e., as bulk material. The feed is performed in a collecting chamber from which the empties are removed by the conveying system. With automatic machines from prior art, the empties are separated serially from the collecting chamber, which in this arrangement, just like with the individual feed system, are then moved past a detection unit which will detect the empties individually in sequence.

DE 10 2006 011 193 A1 discloses a generic device. The conveyance means in this device runs horizontally. It consists of several conveyor belts that are spaced apart, which move the empties past a detection unit, wherein the empties are discharged in the direction of conveyance by a discharge means behind the detection unit into collection tanks placed next to the conveyor. The discharge means, for example, may involve mechanical plungers, which are pneumatically driven, and which, upon activation, push from the bottom to the top through the spaces between the conveyor belts and in this manner remove the empties from the conveyor belts. The discharge means are activated based upon the data detected in the detection unit. If a can is detected, for example, the discharge means assigned to the collection tank for cans is activated. This activation occurs serially.

The bulk feed systems described above are advantageous in that feeding the empties into the device is fast and unproblematic because the empties do not have to be fed individually, one at a time. A disadvantage, however, is that the throughput through the device takes too much time because of the serial separation which follows the feed, despite the occasionally fast individual feed rates of empties.

An object of the present invention, therefore, is to provide a device for the recovery of empties, in particular of plastic bottles and metal cans, with an increased throughput capacity.

The invention teaches that this object is achieved with a device which has the features as disclosed herein.

### SUMMARY

The invention teaches that the removal of the empties from the collecting chamber is parallelized, whereby the empties are supplied to detectors which belong to a detection unit, in a field arrangement. Field arrangement means that the empties on the conveyance means, when viewed in the direction of conveyance, are not only arranged sequentially on top of each other and/or consecutively, but at the same time they are also arranged side-by-side. It should be readily understood that the conveyance means must be designed for this purpose with a width that can generally accommodate at least two average-sized empty items side-by-side.

The parallelization and/or parallel handling of the empties is maintained consistently during their further pass through the device. For this purpose, the discharge means are arranged at least in two rows at different heights across the entire width of the inclined conveyor. The number of rows of discharge means depends on the number of different materials that are accepted by the device. If empties are accepted that consist only of two different materials, such as PET bottles and metal cans, then two rows of discharge means are adequate. Conveyer belts are arranged in front of the inclined conveyor, each at the approximate height of the discharge means, to receive discharged empties and to assist with the parallel transfer of the empties into collection tanks arranged next to the inclined conveyor.

Due to the above described parallelization also of the discharge means, multiple empties can be discharged that the same time. For example, three metal cans that are lying next to each other on the inclined conveyor can be discharged simultaneously onto the assigned conveyor belt, and can be conveyed by it to the respective collection tank.

Thus the throughput of empties by a device that is structured as taught herein, as compared with devices known from prior art, is significantly higher.

Advantageous embodiments of the invention are further disclosed herein.

It is to be understood that both the foregoing description and the following description are exemplary and explanatory only and are not restrictive of the invention, as claimed.

### BRIEF DESCRIPTION OF THE DRAWINGS

The invention is explained in greater detail by means of exemplary embodiments in the following. The associated drawing shows schematically:

FIG. 1 is a side view of the device as taught in a first embodiment,

FIG. 2 is a front view of the first embodiment depicted in FIG. 1, in which the components obstructing the view are omitted,

FIG. 3 is a sectional front view of an inclined conveyor of a device as taught in a second embodiment,

FIG. 4 is a side view of the second embodiment depicted in FIG. 3,

FIG. 5 is an enlarged detail of section A of FIG. 4, and

FIG. 6 is a perspective view of the inclined conveyor where the detection area of a camera belonging to a detection unit is marked, in which the components obstructing the view are omitted.

### DETAILED DESCRIPTION

Reference will now be made in detail to the present exemplary embodiments consistent with the disclosure, examples of which are illustrated in the accompanying drawings. Wherever convenient, the same reference numbers will be used throughout the drawings to refer to the same or like parts.

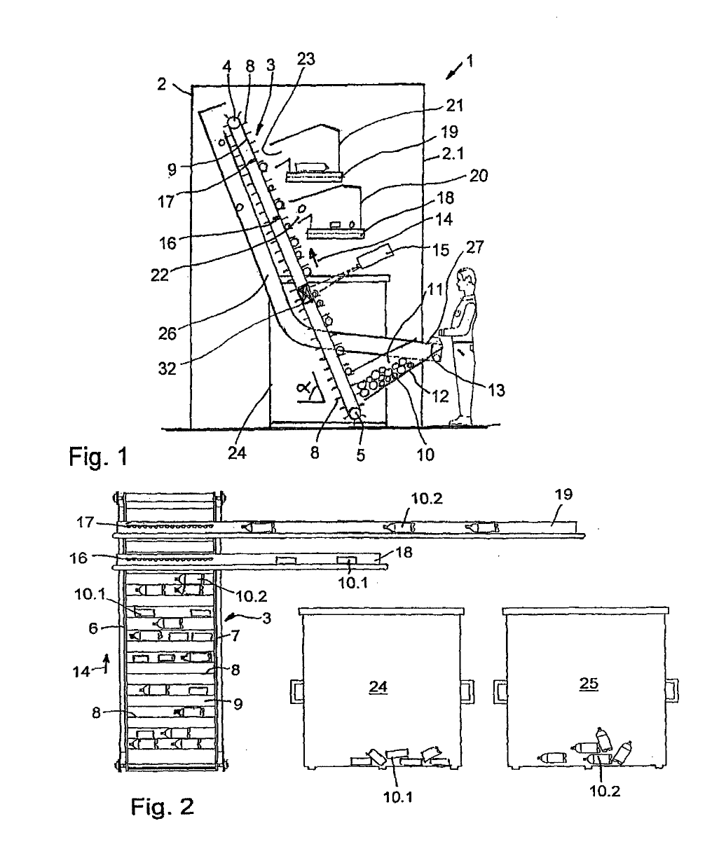

The device 1 represented in FIG. 1 is designed for the recovery of PET bottles 10.2 and metal cans 10.1. It has a housing in the form of a container 2, for example, in which an inclined conveyor 3 is arranged. In this embodiment, the angle of inclination, a, of the inclined conveyor 3 is in the range of 60° to 85°. On both of its longitudinal sides it has chain drives 6, 7 (see FIG. 2) rotating around an upper return pulley 4 and a lower return pulley 5.

According to the exemplary embodiment shown in FIG. 1, at least the upper return pulley 4 is motor-driven. Strip-like tabs 8 are attached on the chain drives 6, 7, transverse to the direction of conveyance (arrow 14 in FIGS. 1 and 2), which are arranged essentially spaced apart equally. A stationary contact surface 9 is arranged behind the carrying side of the inclined conveyor 3, which is intended to prevent any empties 10 lying on the tabs 8 from falling back.

A collecting chamber 11, which is funnel-shaped and open toward the top, is arranged on the lower end of the inclined conveyor 3. The bottom 12 of the collecting chamber 11 runs towards the inclined conveyor 3 sloping down. The collecting chamber 11 extends to the outside through the front wall 2.1 of the container 2, which forms a feed port 13 that is open toward the top. Empties 10 are fed into this feed port 13 by pouring them out of a bag, for example, same as bulk material as it were. Due to the inclination of the bottom 12 of the collecting chamber 11, the empties 10 roll and/or slide by gravity toward the inclined conveyor 3. The tabs 8 of the inclined conveyor 3 run through the collecting chamber 11, as a result of which the empties 10 lying on the tabs 8 are carried along. The tabs 8 transverse to the direction of conveyance 14 are preferably wide enough so that at least two average-sized empty items 10 can lay next to each other on one tab 8.

The inclined conveyor 3 conveys the empties 10 from the collecting chamber 11 to the top past a camera 15 of a detection unit (not shown) and a metal detector 32 (FIG. 1). The camera 15 may be a linescan camera to which a halogen light source has been assigned for illuminating the empties 10 in the incident light. The detection area of the camera 15 preferably encompasses at least the entire width of the inclined conveyor 3. This is programmed for the spectral reflection of polyethylene (PET), so that it detects empties 10 made of PET that are lying on the inclined conveyor 3. At the same time, it also detects the shape and the position of the empties 10 on the inclined conveyor 3. The camera 15 is connected to a control unit (not shown) via a data line (not shown).

Although the camera 15, in the embodiment as described, is designed to detect the shape and position of metal cans 10.1 but not their type of material, a metal detector 32 is provided in addition to the camera 15, as mentioned above. The metal detector preferably includes a plurality of sensors which are arranged in a row behind the contact surface 9 transverse to the direction of conveyance 14. The sensors form individual measuring points, which because of their plurality, facilitate spatial resolution, i.e., they aid in detecting the position of a metal can 10.1 on the inclined conveyor 3, in addition to the camera 15. But they can particularly detect whether the empties 10 are made of metal or not. The metal detector 32 is connected to the control unit also via a data line (not shown). If, for example, the metal cans 10.1 are made of aluminum, eddy current sensors may be used as metal detector 32.

In direction of conveyance 14, above the camera 15 and the metal detector 32, two rows of air nozzles 16 and 17 are arranged transverse to the direction of conveyance 14, which extend across the entire width of the inclined conveyor 3. The contact surface 9 is slotted in the area of the air nozzles 16, 17, so that the outlets of the air nozzles 16, 17 can access the area between the tabs 8.

The control unit (not shown) mentioned above controls the nozzles 16, 17 according to the data acquired (type of empties 10 and their positions on the inclined conveyor 3) by the camera 15 and the metal detector 32. In the embodiment as shown, by selecting the lower row of air nozzles 16, any metal cans 10.1 lying on the tabs 8 are specifically blown-off from the inclined conveyor 3, i.e., the air nozzles 16, which are arranged behind the metal can 10.1 to be removed and/or the metal cans 10.1 to be removed, emit a brief air blast, and, as a result, the metal cans 10.1 are discharged from the inclined conveyor 3. Similarly, in the embodiment as show, by selecting the upper row of air nozzles 17, a corresponding specific removal of PET bottles 10.2 from the inclined conveyor 3 is performed.

Conveyor belts 18, 19 are arranged in the area of the air nozzles 16, 17, respectively, wherein said conveyors extend transversely to the inclined conveyor 3. That is, as shown in FIG. 1, conveyor belt 18 is arranged transversely to air nozzles 16, and conveyor belt 19 is arranged transversely to air nozzles 17. Based on the representation pursuant to FIG. 1, the empties 10 are blown-off by the air nozzles 16 or 17 diagonally to the front and to the top, away from the inclined conveyor 3. At least in the area of the inclined conveyor 3, the conveyor belts 18, 19 have a housing 20 and 21, respectively, which have an access opening 22 and 23, respectively, which are pointing towards the inclined conveyor 3. The empties 15 are blown into the housing 20 or 21 through these access openings 22 or 23, respectively and land on the conveyor belts 18 or 19, respectively.

The lower conveyor belt 18 conveys the metal cans 10.1 into a first collection tank 24, while the conveyor 19 arranged above conveys PET bottles 10.2 into a second collection tank 25.

Any empties 10 that are not detected by the camera 15 and the metal detector 32 are conveyed by the inclined conveyor 3 further to the top, past the air nozzles 16, 17, and, after passing the upper return pulley 4, reach a return chute 26. This return chute 26 extends through the front wall 2.1 of the container 2, and may extend next to the collecting chamber 11 to the outside, thus forming a discharge opening 27 there. Any empties 10 that are accepted by device 1 can be removed from this discharge opening 27.

Next to the feed port 13 and the discharge opening 27, further elements can be arranged in and/or on the front wall 2.1 of the container 2, such as a display (not shown) and a delivery slot (not shown) for a deposit token.

The device 1 has been described above for the recovery of PET bottles 10.2 and metal cans 10.1. This device 1 can naturally also be used for the recovery of different and/or further empties 10. For example, if, in addition to the PET bottles 10.2 and the metal cans 10.1, PVC vapor dispensing bottles are to be recovered, then this merely requires providing a further row of air nozzles, a further conveyor belt, and a further collection tank. Then the camera 15 must be additionally programmed for the detection of PVC.

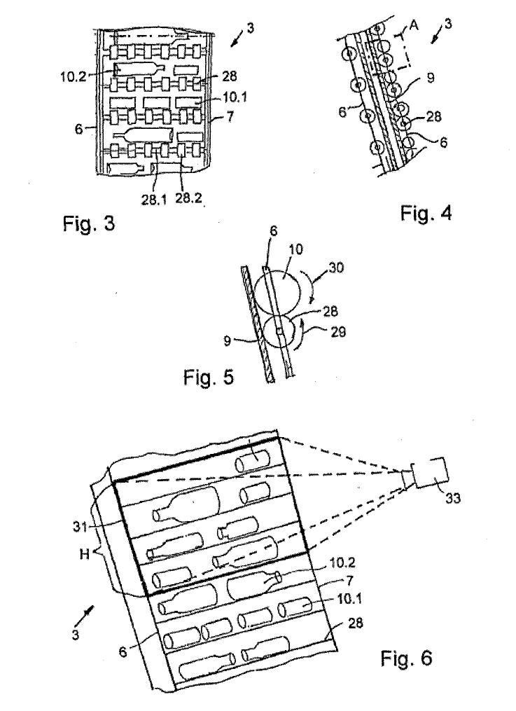

With the device 1 pursuant to the embodiment explained above, empties 10 can be recovered according to their type, metal can 10.1, PET bottles 10.2, etc. If in addition to this, any specific imprints, such as barcodes, safety symbols etc., are to be detected on the periphery of the empties 10, the device 1 must be then modified. With this modified embodiment, the device 1 in principle has the same design like the device illustrated in FIGS. 1 and 2. The differences between the two exemplary embodiments are explained below using FIGS. 3 to 6. For this purpose, the same reference numbers as those used in the first embodiment are used for the same or similar functional components shown in the second embodiment.

The inclined conveyor 3 in the second exemplary embodiment also has rotating chain drives 6, 7 on both of its longitudinal sides, on which, as a difference to the first exemplary embodiment, rollers 28 are arranged transverse to the direction of conveyance 14 are rotatably pivoted. The rollers 28 are generally spaced equal distances apart from one-another, supported on the chain drives 6 and 7, and have alternating sections 28.1, 28.2, with some of the alternating sections having a smaller diameter and some having a larger diameter.

The rollers 28, at least on the carrying side of the chain drives 6, 7, run on a rigid, stationary contact surface 9, and, as a result, they are rotationally driven by means of frictional contact.

In this embodiment, the angle of inclination, α, of the inclined conveyor 3 can be a maximum of 90°. In this case, at least some of the rollers 28 would need to have diameters larger than the largest diameter of the empties 10 to be conveyed, so that the empties 10 do not fall off the rollers 28.

The rollers 28 of the inclined conveyor 3 run through the collecting chamber 11, and the empties 10 lying on the sections 28.2 of the rollers 28 are carried along where the rollers 28 have larger diameters than the empties 10. The rollers 28, transverse to the direction of conveyance 14, are preferably wide enough so that at least two items of empties 10 can rest on one roller 28, as shown in FIG. 3, for example.

During the conveyance of the empties 10 through the inclined conveyor 3, the rollers 28 run on the contact surface 9, as a result of which they are rotationally driven counterclockwise, as represented by arrow 29 in FIG. 3. The empties 10 resting on the rollers 28 will be driven in a clockwise direction as a result, as indicated by arrow 30 in FIG. 4. Due to this direction of rotation, the empties 10 are pressed against the contact surface 9 so that they do not fall off rollers 28.

Also in this exemplary embodiment, the inclined conveyor 3 guides the empties 10 past a camera 33 which belongs to a detection unit (not shown) and past a metal detector 32, as represented in FIG. 6. With respect to this camera 33, it involves a multi-sensor camera, i.e., camera 33 can preferably take pictures as well as performing a spectral analysis.

As an alternative to the multisensory camera, in order to detect imprints on the empties 10, multiple cameras may be used. For example, a second camera (such as a matrix camera) can be utilized in addition to the camera 15 of the first exemplary embodiment (linescan camera) or other type of camera.

The camera 33 has a planar detection area 31. This detection area 31 preferably encloses the entire width of the inclined conveyor 3, and the height H of the detection area 31 is selected such that it preferably corresponds to at least the flattened circumferential surface of the empties 10 which have the largest diameter. In this manner, all identification signs that are on the empties 10, such as barcodes and other pictorial features, can be detected. The camera 33 with corresponding functional lighting is arranged at a specific angle and at a defined distance above the inclined conveyor 3 so that it can detect any marks, etc., that may be present on the periphery of the rotating empties 10 during the conveying upwards, opto-electronically and in real time. Additionally, the camera 33 detects PET bottles 10.2 as well as the position of the empties 10 on the inclined conveyor 3. The material of the metal cans 10.1 as well as their position will in turn be detected by the metal detector 32.

The discharge of the empties 10, and their removal into the collection tanks 24, 25, is performed the same as in the first exemplary embodiment.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1-7. (canceled)

8. A system for the recovery of empties, in particular of plastic bottles and metal cans, comprising:
an inclined conveyor with at least one tab for transporting empties in a field arrangement from a collecting chamber and past a detector of a detection unit;
at least one discharge means for removing the empties from the conveyance means;
at least one conveyor belt at the approximate height of the discharge means for receiving the discharged empties and for transferring the discharged empties into collection tanks.

9. The system of claim 8, wherein the at least one discharge means is an air nozzle controlled with compressed air.

10. The system of claim 9, further comprising a housing for the at least one conveyor belt, wherein the housing comprises an access opening facing the inclined conveyor.

11. The system of claim 9, further comprising a housing for the at least one conveyor belt, wherein the housing comprises an access opening facing the inclined conveyor.

12. The system of claim 8, the inclined conveyor comprising a contact surface for the empties, and the at least one tab supported by two rotating chain drives, wherein the first rotating chain drive is located on the first side of the contact surface and the second rotating chain drive is located on the second side of the contact surface.

13. The system of claim 9, the inclined conveyor comprising a contact surface for the empties, and the at least one tab supported by two rotating chain drives, wherein the first rotating chain drive is located on the first side of the contact surface and the second rotating chain drive is located on the second side of the contact surface.

14. The system of claim 10, the inclined conveyor comprising a contact surface for the empties, and the at least one tab supported by two rotating chain drives, wherein the first rotating chain drive is located on the first side of the contact surface and the second rotating chain drive is located on the second side of the contact surface.

15. The system of claim 11, the inclined conveyor comprising a contact surface for the empties, and the at least one tab supported by two rotating chain drives, wherein the first rotating chain drive is located on the first side of the contact surface and the second rotating chain drive is located on the second side of the contact surface.

16. The system of claim 12, wherein the at least one tab is formed by a plurality of rollers which are pivoted on the rotating chain drives.

17. The system of claim 13, wherein the at least one tab is formed by a plurality of rollers which are pivoted on the rotating chain drives.

18. The system of claim 14, wherein the at least one tab is formed by a plurality of rollers which are pivoted on the rotating chain drives.

19. The system of claim 15, wherein the at least one tab is formed by a plurality of rollers which are pivoted on the rotating chain drives.

20. The system of claim 16, wherein the plurality of rollers are rotated by frictional contact with the contact surface.

21. The system of claim 17, wherein the plurality of rollers are rotated by frictional contact with the contact surface.

22. The system of claim 18, wherein the plurality of rollers are rotated by frictional contact with the contact surface.

23. The system of claim 19, wherein the plurality of rollers are rotated by frictional contact with the contact surface.

24. The system of claim 8, wherein the inclined conveyor has an angle of inclination of 60° to 85°.

25. The system of claim 9, wherein the inclined conveyor has an angle of inclination of 60° to 85°.

26. The system of claim 10, wherein the inclined conveyor has an angle of inclination of 60° to 85°.

27. The system of claim 11, wherein the inclined conveyor has an angle of inclination of 60° to 85°.

28. The system of claim 12, wherein the inclined conveyor has an angle of inclination of 60° to 85°.

29. The system of claim 13, wherein the inclined conveyor has an angle of inclination of 60° to 85°.

30. The system of claim 14, wherein the inclined conveyor has an angle of inclination of 60° to 85°.

31. The system of claim 15, wherein the inclined conveyor has an angle of inclination of 60° to 85°.

32. The system of claim 16, wherein the inclined conveyor has an angle of inclination of 60° to 85°.

33. The system of claim 17, wherein the inclined conveyor has an angle of inclination of 60° to 85°.

34. The system of claim 18, wherein the inclined conveyor has an angle of inclination of 60° to 85°.

35. The system of claim 19, wherein the inclined conveyor has an angle of inclination of 60° to 85°.

36. The system of claim 20, wherein the inclined conveyor has an angle of inclination of 60° to 85°.

37. The system of claim 21, wherein the inclined conveyor has an angle of inclination of 60° to 85°.

38. The system of claim 22, wherein the inclined conveyor has an angle of inclination of 60° to 85°.

39. The system of claim 23, wherein the inclined conveyor has an angle of inclination of 60° to 85°.
